(19) United States
(12) Patent Application Publication
(10) Pub. No.: US 2025/0307240 A1
(43) Pub. Date: Oct. 2, 2025

(54) AUTOMATIC ENTERPRISE DATABASE AND QUERY OPTIMIZATION

(71) Applicant: The PNC Financial Services Group, Inc., Pittsburgh, PA (US)

(72) Inventor: Clifton Denning, Owings, MD (US)

(21) Appl. No.: 19/092,710

(22) Filed: Mar. 27, 2025

Related U.S. Application Data
(60) Provisional application No. 63/573,017, filed on Apr. 2, 2024.

(51) Int. Cl. G06F 16/2453; G06F 16/242; G06F 16/28

(52) U.S. Cl. CPC G06F 16/2453; G06F 16/243; G06F 16/285

(57) ABSTRACT

Systems and methods automatically optimize database queries for a distributed database management platform of an enterprise. A server system of a distributed database management platform receives data queries from users associated with the enterprise for data stored in the distributed database management platform. The server system assigns a score to each of the data queries, with the score for a data query being indicative of a quality of the data query. The server system generates, based on the scores for the data queries, a general score for at least one user group. The server system automatically undertakes a computing query optimization action for the at least one user group based on the general score for the at least one user group.

PRIORITY CLAIM

The present application claims priority to U.S. provisional application Ser. No. 63/573,017, filed Apr. 2, 2024, titled “Automatic Enterprise Database and Query Optimization,” which is incorporated herein by reference in its entirety.

### BACKGROUND

Enterprise networks are generally made up of hundreds or thousands of users on computing devices connected on a network with servers, databases, mainframes and data centers belonging to an enterprise. Users may be divided into various business units or into groups that submit queries via the enterprise servers to retrieve data or information from databases of the enterprise relevant to the task of the user or the group. The querying of databases, the subsequent production of query results and the retrieval of data all use network and computing resources.

### SUMMARY

In one general aspect, the present invention is directed to computer-implemented systems and methods for automatic optimization of database queries to encourage and automatically enforce best practices for database querying across business units in an enterprise. This can be done in a variety of ways disclosed herein including identifying database queries that follow best practices and those that follow poor practices, scoring database queries based on their efficiency, effectiveness, or based on their compliance with best practices, and identifying and scoring user and business units based on their submitted queries and then undertaking enforcement or notification mechanisms on business units with poor compliance or low quality database queries.

In some aspects, what is disclosed are automated systems and methods to train a machine learning model or neural network to generate an optimized database partition structure based on the needs of a business unit or based on the needs of the enterprise network based on the types of queries they submit. In various aspects, the trained database optimization model takes in as training inputs the multitude of database queries submitted by enterprise users, applying transformations to them such as by applying pre-processing or labeling techniques on them to generate training data, which it is then used to train one or more neural networks or machine learning models. Based on this training, the neural network/ML model is then able to determine whether current database structures and partitions are optimal, and if not, then proceeds to generate database structures and models that are optimal versions of the databases currently deployed by the enterprise network.

These and other benefits that can be realized through various embodiments of the present invention will be apparent from the description that follows.

### BRIEF DESCRIPTION OF DRAWINGS

Various embodiments of the present invention are described herein by example in connection with the following figures.

FIG. 1 illustrates one embodiment of an architecture of an enterprise system for automatic enterprise database and query optimization.

FIG. 2 illustrates in a diagrammatical format, one embodiment of a method of automatic enterprise database and query optimization.

FIG. 3 illustrates one embodiment of a flow diagram illustrating a method for training a neural network for database optimization.

FIG. 4 is a diagram of a feed-forward neural network.

FIG. 5 is a diagrammatic representation of an example system that includes a host machine within which a set of instructions to perform any one or more of the methodologies discussed herein may be executed, according to at least one aspect of the present disclosure.

FIG. 6 is a diagram of a computer system that can be used to train a neural network according to embodiments of the present invention.

### DETAILED DESCRIPTION

Hadoop or other on-premises cloud computing environments and platforms are deployed in enterprise networks as data management solutions for businesses, enterprises and other organizations and agencies to manage data storage and retrieval across the organization and for various programs and applications used by various business units in the enterprise, in a uniform and universal manner that can be replicated across various units or groups of an organization. Other examples of data management solutions include Databricks™, Google BigQuery™, Cloudera™, Apache Spark™, Apache Storm™, Big Query™, Presto™, and Horton Data Platform™ as well as other data management systems.

Hadoop, in particularly, is a collection of open-source software utilities that facilitates using a network of many computers to solve problems involving massive amounts of data and computation. It provides a software framework for distributed storage and processing of big data using the MapReduce programming model. The core of Hadoop consists of a storage part, known as Hadoop Distributed File System (HDFS), and a processing part which is a MapReduce programming model. Hadoop splits files into large blocks and distributes them across nodes in a cluster. It then transfers packaged code into nodes to process the data in parallel. This approach takes advantage of data locality, where nodes manipulate the data they have access to. This allows the dataset to be processed faster and more efficiently than it would be in a more conventional supercomputer architecture that relies on a parallel file system where computation and data are distributed via high-speed networking.

Users submit queries to data management systems like Hadoop to obtain, access, or retrieve data across one or more applications. However, the process can be inefficient. In Hadoop, the MapReduce reads and writes data to and from a disk of a hard disk drive. For every stage in processing the data get read from the disk and written to the disk. These disk seek operations take time, thereby making the process somewhat slow, especially if it is processing small volumes of data. As such, inefficient queries use much more enterprise or network resources than is required. In an enterprise setting with hundreds or thousands of users and computing devices in various business units, even a small number of these business units submitting inefficient queries and using disproportionate amounts of resources could cause resource usage issues for the enterprise's network. This is problematic on an enterprise level where other users may be slowed down or have less resources available to them due to inefficient queries from other users or business units.

The present invention presents, in various embodiments, is directed to an automated software module or tool (“tool”) and related systems and methods that are able to iterate through queries that are submitted or that have been previously submitted by users in an enterprise, and identify in these queries evidence of poor practice or evidence that a best data query practice(s) is not followed, or otherwise identify queries of certain characteristics. The tool can for example look for patterns in or among the queries and generate or assign a score (e.g., 0.00 to 1.00, or 0 to 100) based on the quality of each query analyzed. For example, lower scores can indicate lower quality queries and vice versa. The tool then can identify users and/or groups of users within the organization with poor practice queries and apply query improvement mechanisms to improve their queries and make the users (and their data queries) more efficient.

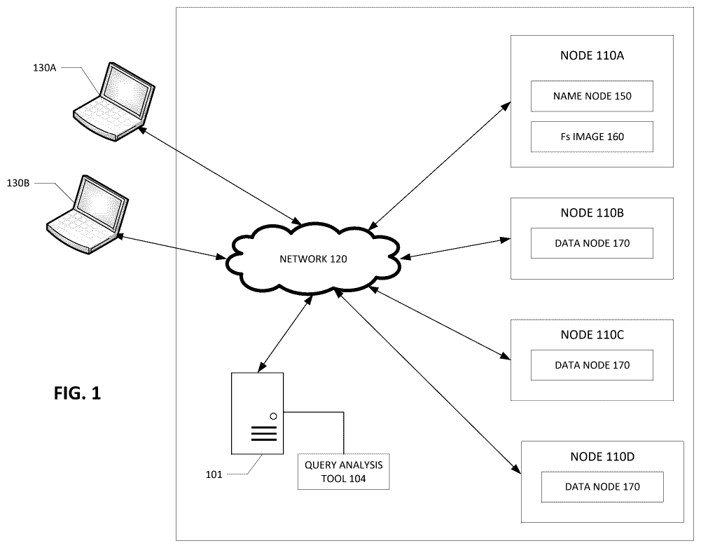

The system may incorporate a distributed database management framework, which may include, but is not limited to, Hadoop-based architectures or similar distributed computing environments. Key terms such as “distributed database,” “fault tolerance,” and “data partitioning” may be understood in the context of large-scale data management. FIG. 1 illustrates an example of a Hadoop cluster and a query analysis tool 104, according to various embodiments of the present invention, that is run on a server 101, for example. The illustrated embodiment is described in the context of a Hadoop cluster, although the query analysis tool 104 could be used with other distributed data management systems besides Hadoop. Focusing first on the Hadoop cluster 100 in FIG. 1, it includes a metadata node 110A and a plurality of data nodes 110B, 110C and 110D. The nodes can communicate with each other through an electronic data network 120, such as, for example, a local area network (LAN), wide area network (WAN), metropolitan area network (MAN), global area network such as the Internet, a Fibre Channel fabric, or any combination of networks. Clients 130A and 130B may communicate with the Hadoop cluster 100 via the network 120, which can be, for example, the Internet, a LAN, or any other type of network or combination of networks. Each of the clients may be, for example, a conventional personal computer (PC), server-class computer, workstation, handheld computing/communication device, or the like. In some embodiments, the Hadoop cluster is implemented using one or more racks of commodity-class servers. Each data node 110B-D can run on a separate physical server equipped with local storage (hard drives or SSDs) to store the data blocks. The metadata node 100A can also run on a server, which may have more memory and processing power than the data nodes because it manages the metadata, as described herein.

Files and data are stored in a distributed manner across the nodes in the Hadoop cluster 100 in a Hadoop Distributed File System (HDFS). To the clients of the cluster 100, including clients 130A and 130B, the HDFS serves functions of a conventional hierarchical file system. Files and data blocks of files can be created, deleted, or moved in the HDFS. There is a NameNode service 150 running on the metadata node 110A to provide metadata services within HDFS, including maintaining the file system namespace and controlling access by external clients. The NameNode service can store the file system index, including the mapping of blocks to files and file system properties, in a file 160 called FsImage in the metadata node. The NameNode need not store actual data, instead tracking where the data blocks are located across the data nodes. In some embodiments, there may be a secondary metadata node running a secondary NameNode service. The secondary metadata node serves as a backup in case the metadata node fails.

Each data node 110 is responsible for storing files for the HDFS. Files stored in the HDFS are divided into subsets, referred to herein as “blocks,” which may be, for example, 64 MBs in size. The blocks are typically replicated to multiple data nodes. Therefore, the HDFS in the Hadoop cluster 100 can, but does not necessarily, use a conventional RAID architecture to achieve data reliability. File operations are controlled by the NameNode service 150 running on the metadata node 110A. In some embodiments, data nodes 110B, 110C, 110D are organized into racks where all nodes are connected via a network switch. The network speed between nodes within a rack can be faster than the network speed between nodes in different racks. The Hadoop cluster may take that fact into account when assigning tasks. A DataNode service 170 runs on each data node 110B-D for responding read and write requests for blocks. The DataNode services 170 also respond to requests from the metadata node for creating, deleting and replicating blocks.

When a client 130A or 130B seeks to write a file to the Hadoop cluster 100, the client sends a file creation request to the metadata node 110A. The metadata node 110A responds to the client with the identity of one or more assigned data node(s) and the destination locations of the blocks of the files. The client sends data blocks of the file to the assigned data node(s); and the cluster can replicate the data blocks on one or more data nodes. Once all blocks are sent, the metadata node records the file creation in its metadata, including the FsImage file.

In a Hadoop cluster and for other data management solutions, user queries for data, such as from the clients 130A-B, are often in the form of Structured Query Language (SQL) queries. The queries can be handled using components like Apache Hive or Apache Impala of the enterprise's network. Hive translates SQL-like queries into MapReduce or Tez jobs, while Impala uses a massively parallel processing (MPP) architecture to execute SQL queries directly on Hadoop data without MapReduce. Both aim to provide SQL interfaces for querying data stored in Hadoop Distributed File System (HDFS) or other compatible file systems, making data analysis more accessible in the Hadoop ecosystem. The Hive and/or Impala components may be part of, for example, the enterprise server 101 shown in FIG. 1. The enterprise server 101 may comprise (that is, run or execute) the query analysis tool 104 to analyze user data queries to the data management solution (e.g., Hadoop cluster) according to various embodiments of the present invention. The enterprise server 101 is shown in FIG. 1 as separate from (although connected to via the network 102) the nodes 110A-D, although in other embodiments the query analysis tool 104 and/or the Hive/Impala components could be part of one of the nodes, such as the node 110A.

The system may be implemented using a master-slave architecture, a shared-nothing architecture, or other distributed configurations. Data storage and retrieval may be performed using a distributed file system, such as HDFS, or alternative storage solutions. The system may distribute data across multiple nodes for parallel processing. Queries may be executed using a distributed query execution engine, which may optimize execution through indexing, caching, or sharding techniques. A fault tolerance mechanism may be implemented, wherein data replication and redundancy strategies enable recovery in the event of node failures. The system may adhere to principles of the CAP theorem and may balance consistency, availability, and partition tolerance based on deployment needs. Various synchronization techniques, such as quorum-based consensus mechanisms or event-driven updates, may be employed to ensure data integrity across distributed nodes. The system may adhere to principles of the CAP theorem and may balance consistency, availability, and partition tolerance based on deployment needs. Various synchronization techniques, such as quorum-based consensus mechanisms or event-driven updates, may be employed to ensure data integrity across distributed nodes.

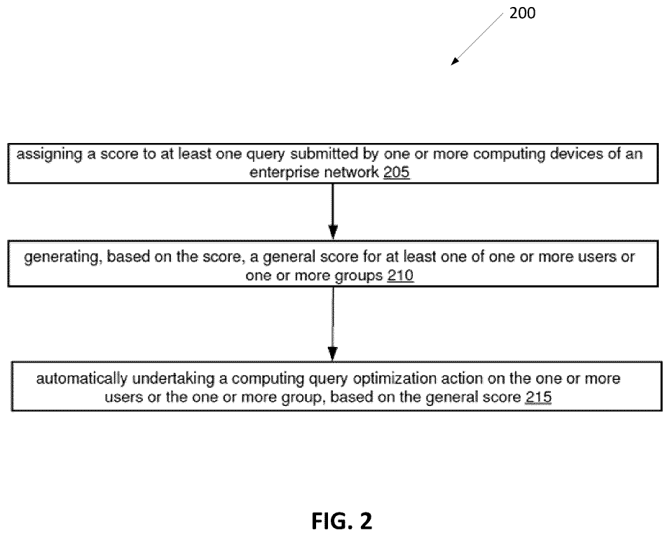

FIG. 2 illustrates in a diagrammatical format, one embodiment of a method of automatic enterprise database and query optimization. Now primarily referring to FIG. 2 with continued reference to FIG. 1, method 200 can be executed by the query analysis tool 104 or any of the systems disclosed herein. Method 200 for optimization of database queries can comprise assigning, at step 205, a score, respectively, to queries submitted by a user computing device 130A-B of the enterprise network. In several aspects, the queries are submitted to the enterprise's database management platform, such as the Hadoop cluster 100. In particular, the queries may be routed to a server system, e.g., the enterprise server 101, with the query analysis tool 104. The queries may be SQL queries submitted to the database management system such as the Hadoop cluster but is not limited to such aspects. In several aspects, the step of assigning the score(s) to the query(ies) may be based on identification of patterns associated with high quality or low-quality database/SQL queries. In several aspects the assignment of the score is undertaken in real time by the query analysis tool 104, for example upon receipt of each query, while in other embodiment the scoring of a query may be performed after receipt of the query, for example by examining a log that includes previously submitted queries to the database management system.

In several aspects, the assigning of the score at step 205 includes first comparing one or more parameters or portion of each query to specific parameter criteria, to identify patterns in the queries. Parameter criteria can set out rules or templates for whether a query follows best practices established or adopted by the enterprise, or whether it does not follow best practice. Therefore, a determination can be made by the query analysis tool 104 as to whether a query as a whole is one that is a high quality query (that follows at least a threshold of best practice patterns) or a low quality query (that falls below a threshold of best practice patterns) as represented by the assigned score. The scores may range from 0.00 to 1.00 or from 0 to 100, for example, with lower scores representing lower quality and higher scores representing higher quality. In various aspects, step 205 can include, by the software analysis tool 104, comparing at least one query parameter of a query to one or more (predetermined or predefined) parameter criteria to identify one or more query patterns, where each of the one or more query patterns may in many aspects, be associated with a specific quality categorization (e.g. a pattern with a high quality parameter or a low quality parameter, or one that is neutral), where the specific quality categorization may be associated with a score, number or multiplier. In such cases, the assigning step 205 may then comprise generating a score to assign for the at least one query based on a presence (or non-presence) of the one or more query patterns that are identified in the at least one query.

In several aspects the query patterns that affect the scoring can include, for example, (i) unbalanced joins between different tables retrieved, (ii) use of star select (*[term]) in a query to be scored, where the “*” is a wildcard notation for all data from a data table, (iii) lack of filtering techniques in the query, and/or (iv) requesting excess data and/or using excess network resources by the query over what is required to resolve the query.

Once a score has been generated, calculated or assigned at step 205 for each query that is assessed, one or more users or business units within the enterprise may be identified as being associated with each query. Queries coming from a specific business unit, a specific user, and/or a specific group within the enterprise may then be grouped together and then the method 200 can include generating, at step 210, a general or aggregated score for specific business unit, user, or group, as the case may be, based on the scores that were assigned at step 205 for each query and/or the categorization of each query associated with that user, business unit and/or group as one that follows best practice or not. The generating 210 step can in some examples include generating an average score for each user, group, or business unit, as the case may be, based on the score(s) assigned at step 205 for each individual query.

In several aspects, the method 200 can also include automatically undertaking, at step 215, a computing query optimization action on the one or more users, group or business unit (as the case may be) based on the general score. In several aspects this is only done when the score from step 205 or the general score from step 210 meets, is above, or is below a predetermined threshold or score. This query optimization action can include a simple notification from the query analysis too 104, such as an alert sent to, and displayed on, a user interface of the user device 130A-B, an actionable notification, such as an interactive alert on the user interface, or an enforcement mechanism on the enterprise network.

The enforcement mechanism can include reducing a capability of the user, business unit or group (as the case may be) to submit queries, for example, by reducing network computing resources available to accounts associated with the user, group, or business unit (e.g., fewer processors or cloud services allocated to the user, group or BU, or a limit on a number of queries in a specified time period) and/or by placing the accounts of the user, group or business unit in a longer query submission queue time, for example by throttling the network bandwidth associated with the user, group, or business unit. For example, the enterprise server 101, or some other server of the network 100, can reduce network resources available to the user/group through various means such as bandwidth throttling for computers/accounts associated with the user/group, enforcing access controls to network resources for the user/group, setting reduced Quality of Service configurations for the user/group, implementing limitations on data transfer rates for the user/group, and/or implementing access permissions based on user roles or priorities. The query submission queue time for the user/group can be lengthened by adjusting the priority of the user's/group's queries to the distributed database management platform, modifying the platform resources allocated to the queries of the user/group, and/or by implementing policies that grant certain user higher (or lower) access or quicker processing times within the queue system.

In several aspects, the computing query optimization action comprises an actionable notification, where the actionable notification comprises at least one of: providing a selectable option to amend the query to a recommended query (this can be provided on an interactive UI) that allows a user to select from various options of recommended or improved queries relative to the query submitted by the user. In various aspects, the tool 104 might assign a score at step 205 and then undertake, at step 215, a computing enforcement mechanism such as providing better query options for that individual query without generating, at step 210, a general or aggregated score based on multiple queries. In these aspects each query is assessed individually and then computing enforcement mechanisms are undertaken at step 215 in response without performing step 210.

In many aspects, the computing query optimization action comprises a notification provided to the user, group or business unit that includes information on excess resources used by the queries from the user, group or business unit, based on the queries therefrom. Alternatively or additionally, the notification can be an alert that a query is not optimized, an alert that the query has received a specific categorization (e.g., low quality query), or an alert to provide an interface for the one or more users or the one or more groups to navigate to an interactive user interface (interactive UI).

In several aspects an interactive UI utilized by the method 200 allows the users, group or business unit to navigate through a history of previous submitted queries, informatics or graphics that may be related to recommendations on improvements to the queries, or initiate an interactive query training module through current or previous query submissions where the score of each query is displayed with reasons for the scoring and tips of recommendations for improving the query. In several aspects, the method 200 includes creating an optimal data structure or partitions of the database based on the scores (from step 205) or general scores (from step 210) to improve the efficiency of future data queries and retrievals. The creation of optimal data queries and retrievals can be done automatically.

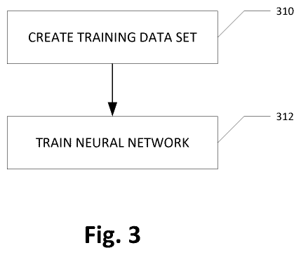

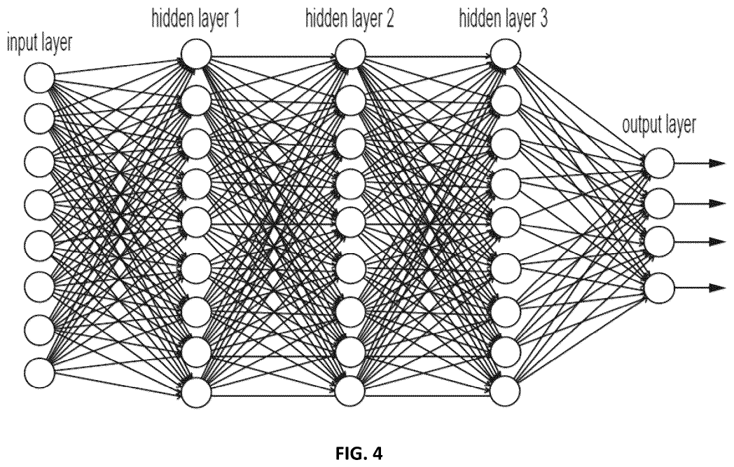

In addition, or alternatively, to training users based on the query scores, the analysis of the user queries can be used to partition the enterprise's network into different partitions, where the repartitioning allows more efficient processing of the users' queries. This process can involve a machine-learning trained model, e.g., a neural network, that is trained based on labeled user queries. FIG. 3 illustrates one embodiment of a flow diagram illustrating a method for training such a neural network for database optimization. At step 310, a training data set is created. The training data set can be created by labeling prior database queries, e.g., queries stored in a query log for the enterprise. The label for each training query can be the scores, or score classifications from the scores (e.g., high quality query, low quality query) from the process of FIG. 3. Then, at step 312, the model (e.g. a deep neural network) is trained with the labeled training data. A deep neural network is, as shown in FIG. 4, a type of artificial neural network composed of multiple hidden layers between input and output layers. These layers contain interconnected nodes that process and transform input data through weighted connections, enabling the network to learn intricate patterns and representations from complex data. The network is trained iteratively to determine the weights of the connections and biases that are applied by the nodes in computing activation values.

The neural network can be trained iteratively using gradient descent or stochastic gradient descent. Iterative training of a deep neural network can involve multiple cycles (or iterations) of feeding the training data through the network, adjusting its learned parameters (e.g., connection weights and biases) based on the calculated errors, and repeating this process to minimize the errors further. This gradual refinement, typically performed using an optimization algorithm such as gradient descent or stochastic gradient descent, enhances the network's ability to make accurate predictions by learning from the data it is exposed to.

In several aspects the method 200 of FIG. 2 and the method 300 of FIG. 3 are separate methods and processes. However, in various aspects, the method 300 can be combined with any of the one or more of the processes disclosed in the method 200. [can you describe how they might go together?].

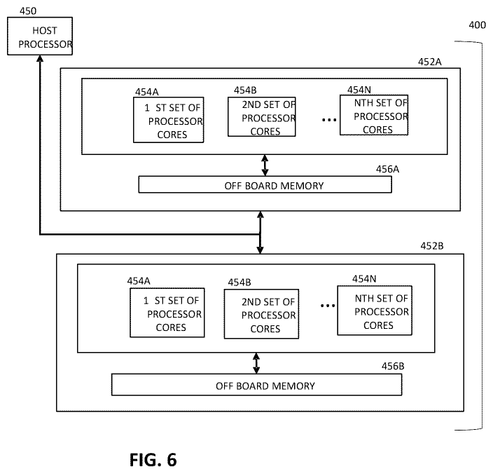

FIG. 6 is a diagram of a computer system 400 that can be used to train the neural network described in connection with FIGS. 3 and 4. The illustrated computer system 400 comprises multiple processor units 452A-B that each comprises, in the illustrated embodiment, multiple (N) sets of processor cores 454A-N. Each processor unit 452A-B may comprise on-board memory (ROM or RAM) (not shown) and off-board memory 456A-B. The on-board memory may comprise primary, volatile and/or non-volatile storage (e.g., storage directly accessible by the processor cores 454A-N). The off-board memory 456A-B may comprise secondary, non-volatile storage (e.g., storage that is not directly accessible by the processor cores 454A-N), such as ROM, HDDs, SSD, flash, etc. The processor cores 454A-N may be CPU cores, GPU cores and/or AI accelerator cores. GPU cores operate in parallel (e.g., a general-purpose GPU (GPGPU) pipeline) and, hence, can typically process data more efficiently that a collection of CPU cores, but all the cores of a GPU execute the same code at one time. AI accelerators are a class of microprocessor designed to accelerate artificial neural networks. They typically are employed as a co-processor in a device with a host CPU 450 as well. An AI accelerator typically has tens of thousands of matrix multiplier units that operate at lower precision than a CPU core, such as 8-bit precision in an AI accelerator versus 64-bit precision in a CPU core.

In other embodiments, the system 400 could be implemented with one processor unit 452. In embodiments where there are multiple processor units, the processor units could be co-located or distributed. For example, the processor units 452 may be interconnected by data networks, such as a LAN, WAN, the Internet, etc., using suitable wired and/or wireless data communication links. Data may be shared between the various processing units 452 using suitable data links, such as data buses (preferably high-speed data buses) or network links (e.g., Ethernet).

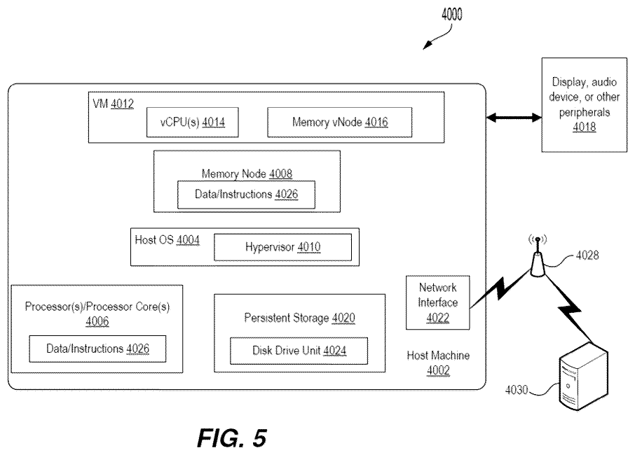

FIG. 5 is a diagrammatic representation of an example system 4000 that includes a host machine 4002, which can be the enterprise server 101 or one of the nodes 110A-D of FIG. 1. The host machine 4002 comprises a set of instructions to perform, when executed by a processor(s) of the host machine 4002, any one or more of the methodologies discussed herein, such as the instructions for the query analysis tool 104. In various aspects, the host machine 4002 operates as a standalone device or may be connected (e.g., networked) to other machines, such as noes 110A-D of the database cluster 100. In a networked deployment, the host machine 4002 may operate in the capacity of a server or a client machine in a server-client network environment, or as a peer machine in a peer-to-peer (or distributed) network environment. The host machine 4002 may be a server or other type of computing device capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 4000 includes the host machine 4002, running a host operating system (OS) 4004 on a processor or multiple processor(s)/processor core(s) 4006 (e.g., a central processing unit (CPU), a graphics processing unit (GPU), or both), and various memory nodes 4008. The host OS 4004 may include a hypervisor 4010 which is able to control the functions and/or communicate with a virtual machine (“VM”) 4012 running on machine readable media. The VM 4012 also may include a virtual CPU or vCPU 4014. The memory nodes 4008 may be linked or pinned to virtual memory nodes or vNodes 4016. When the memory node 4008 is linked or pinned to a corresponding vNode 4016, then data may be mapped directly from the memory nodes 4008 to their corresponding vNodes 4016.

All the various components shown in host machine 4002 may be connected with and to each other or communicate to each other via a bus (not shown) or via other coupling or communication channels or mechanisms. The host machine 4002 may include for example a persistent storage device 4020 (e.g., a disk drive unit) and a network interface device 4022. The host machine 4002 may further include a data encryption module (not shown) to encrypt data. The components provided in the host machine 4002 are those typically found in computer systems that may be suitable for use with aspects of the present invention and are intended to represent a broad category of such computer components that are known in the art. Thus, the system 4000 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 4024 also may be a Solid-state Drive (SSD), a hard disk drive (HDD) or other includes a computer or machine-readable medium on which is stored one or more sets of instructions and data structures (e.g., data/instructions 4026, such as instructions for the query analysis tool 104) embodying or utilizing any one or more of the methodologies or functions described herein. The data/instructions 4026 also may reside, completely or at least partially, within the main memory node 4008 and/or within the processor(s) 4006 during execution thereof by the host machine 4002. The data/instructions 4026 may further be transmitted or received over a network 4028 via the network interface device 4022 utilizing any one of several well-known transfer protocols (e.g., Hyper Text Transfer Protocol (HTTP)). The network 4028 (as well as the network 120 in FIG. 1) may be a LAN, WAN, the Internet, or any other suitable type of electronic data network.

The processor(s) 4006 and memory nodes 4008 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 4002 and that causes the host machine 4002 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34b is analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 4030 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 4002, with each server 4030 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In one general aspect, therefore, the present invention is directed to a computer-implemented method for automatic optimization of database queries for a distributed database management platform of an enterprise. The method comprises, according to various embodiments, the step of receiving, by a server system of the distributed database management platform, data queries from users associated with the enterprise for data stored in the distributed database management platform. The method may also comprise the step of assigning, by the server system, a score to each of the data queries, where the score for a data query is indicative of a quality of the data query. The method can also comprise the step of generating, by the server system, based on the scores for the data queries, a general score for at least one user group. The at least one user group comprises one or more users that are associated with the enterprise. The method also comprises the step of automatically undertaking a computing query optimization action for the at least one user group based on the general score for the at least one user group.

In another general aspect, the present invention is directed to a database system for an enterprise. The database system comprises (i) a distributed database management platform comprising a plurality of nodes configured to store and process data queries; and (ii) a server in communication with the distributed database management platform. The server is configured to execute a data query analysis application that: receives data queries from users associated with the enterprise for data stored in the distributed database management platform; assigns a score to each of the data queries, where the score for a data query is indicative of a quality of the data query; generates, based on the scores for the data queries, a general score for at least one user group, where the at least one user group comprises one or more users that are associated with the enterprise; and automatically undertakes a computing query optimization action for the at least one user group based on the general score for the at least one user group.

In various implementations, the distributed database management platform comprises a Hadoop distributed database management platform.

In various implementations, the data queries comprise SQL queries.

In various implementations, the computing query optimization action comprises reducing an ability of the at least one user group to submit data queries to the distributed database management platform. For example, reducing the ability of the at least one user group to submit data queries to the distributed database management platform can comprise reducing computing resources of enterprise available to accounts associated with the at least one user group or placing accounts associated with the at least one user group in a longer query submission queue time for the distributed database management platform.

In various implementations, the computing query optimization action comprises an actionable notification, where the actionable notification comprises at least one of providing an option to amend a data query to a recommended data query, information on excess resources used by a data query, an alert that a data query is not optimized, or an alert that a data query has received a specific categorization.

In various implementations, the computing query optimization action comprises display an interactive UI for the at least one user group, where the interactive AI allows the at least one user group to navigate through a history of previously submitted data queries from the at least one user group, recommendations on improvements to the previously submitted data queries, or an interactive query training module.

In various implementations, the computing query optimization action is undertaken based on the general score being below a predetermined threshold score.

In various implementations, the server system assigns a category classification for each of the data queries, where the category classification for each data query is indicative of a quality of the data query.

In various implementations, the score for each data query is based on a presence of at least one query parameter in the data query. Also, the at least one query parameter can comprise at least one of unbalanced joins between different tables, use of star select in the data query, lack of filtering techniques in the data query, or requesting excess data by the data query over what is required to resolve the data query.

In various implementations, assigning of the score can comprise: comparing at least one query parameter of the data query to one or more parameter criteria to identify one or more query patterns, where each of the one or more query patterns is associated with a specific quality category classification; and generating the score to assign to the data based on a presence of the one or more query patterns in the data query. Also, the assigned score can be further based on a computing resource usage associated with the data query or the at least one query parameter.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random-access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer readable medium, such as RAM, ROM, a magnetic medium such as a hard-drive or a floppy disk, or an optical medium such as a CD-ROM. Any such computer readable medium may reside on or within a single computational apparatus, and may be present on or within different computational apparatuses within a system or network.

Some further descriptions of terms used herein are provided below.

An “application” may include any software module configured to perform a specific function or functions when executed by a processor of a computer. For example, a “mobile application” may include a software module that is configured to be operated by a mobile device. Applications may be configured to perform many different functions. An “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, touchscreen, etc.).

The terms “client device” and “user device” refer to any electronic device that is configured to communicate with one or more servers or remote devices and/or systems. A client device or a user device may include a mobile device, a network-enabled appliance (e.g., a network-enabled television, refrigerator, thermostat, and/or the like), a computer, a POS system, and/or any other device or system capable of communicating with a network. A client device may further include a desktop computer, laptop computer, mobile computer (e.g., smartphone), a wearable computer (e.g., a watch, pair of glasses, lens, clothing, and/or the like), a cellular phone, a network-enabled appliance (e.g., a network-enabled television, refrigerator, thermostat, and/or the like), a point of sale (POS) system, and/or any other device, system, and/or software application configured to communicate with a remote device or system. A client or user device may also include an access device as defined in this application.

As used herein, the term “communication” and “communicate” may refer to the reception, receipt, transmission, transfer, provision, and/or the like of information (e.g., data, signals, messages, instructions, calls, commands, and/or the like). A communication may use a direct or indirect connection and may be wired and/or wireless in nature. As an example, for one unit (e.g., a device, a system, a component of a device or system, combinations thereof, and/or the like) to communicate with another unit means that the one unit is able to directly or indirectly receive information from and/or transmit information to the other unit. The one unit may communicate with the other unit even though the information may be modified, processed, relayed, and/or routed between the one unit and the other unit. In one example, a first unit may communicate with a second unit even though the first unit receives information and does not communicate information to the second unit. For example, a first unit may be in communication with a second unit even though the first unit passively receives data and does not actively transmit data to the second unit. As another example, a first unit may communicate with a second unit if an intermediary unit (e.g., a third unit located between the first unit and the second unit) receives information from the first unit, processes the information received from the first unit to produce processed information, and communicates the processed information to the second unit. In some non-limiting embodiments or aspects, a message may refer to a packet (e.g., a data packet, a network packet, and/or the like) that includes data. It will be appreciated that numerous other arrangements are possible.

As used herein, the term “computing device” or “computer device” may refer to one or more electronic devices that are configured to directly or indirectly communicate with or over one or more networks. A computing device may be a mobile device, a desktop computer, and/or the like. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may not be a mobile device, such as a desktop computer. Furthermore, the term “computer” may refer to any computing device that includes the necessary components to send, receive, process, and/or output data, and normally includes a display device, a processor, a memory, an input device, a network interface, and/or the like.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

As used herein, the term “server” may include one or more computing devices which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices may constitute a “system”.

Reference to “a server” or “a processor,” as used herein, may refer to a previously recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

A “server computer” may typically be a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

A “user” may include an individual. In some embodiments or aspects, a user may be associated with one or more personal accounts and/or mobile devices. The user may also refer to a “user data object” associated with a user, or a data object that signifies or identifies a user, where the user object can comprise ‘user information’ or data associated with the user, for example the phrase “adding a user to a group” can signify adding the user data object or data associated to it, including and not limited to user information, metadata, identifiers, tokens or other data related to a user or user data object.

Likewise, a “group” can indicate grouping users under a data object or file, or of a data object that signifies a group. The data object related to the group includes and is not limited to information, metadata, identifiers, tokens or other data related to a group or group data object.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A computer-implemented method for automatic optimization of database queries for a distributed database management platform of an enterprise, the method comprising:
receiving, by a server system of the distributed database management platform, data queries from users associated with the enterprise for data stored in the distributed database management platform;
assigning, by the server system, a score to each of the data queries, wherein the score for a data query is indicative of a quality of the data query;
generating, by the server system, based on the scores for the data queries, a general score for at least one user group, wherein the at least one user group comprises one or more users that are associated with the enterprise; and
automatically undertaking a computing query optimization action for the at least one user group based on the general score for the at least one user group.

2. The computer-implemented method of claim 1, wherein the distributed database management platform comprises a Hadoop distributed database management platform.

3. The computer-implemented method of claim 1, wherein the data queries comprise SQL queries.

4. The computer-implemented method of claim 1, wherein the computing query optimization action comprises reducing an ability of the at least one user group to submit data queries to the distributed database management platform.

5. The computer-implemented method of claim 4, wherein reducing the ability of the at least one user group to submit data queries to the distributed database management platform comprises reducing computing resources of enterprise available to accounts associated with the at least one user group.

6. The computer-implemented method of claim 4, wherein reducing the ability of the at least one user group to submit data queries to the distributed database management platform comprises placing accounts associated with the at least one user group in a longer query submission queue time for the distributed database management platform.

7. The computer-implemented method of claim 1, wherein the computing query optimization action comprises an actionable notification, wherein the actionable notification comprises at least one of providing an option to amend a data query to a recommended data query, information on excess resources used by a data query, an alert that a data query is not optimized, or an alert that a data query has received a specific categorization.

8. The computer-implemented method of claim 1, wherein the computing query optimization action comprises display an interactive UI for the at least one user group, wherein the interactive AI allows the at least one user group to navigate through a history of previously submitted data queries from the at least one user group, recommendations on improvements to the previously submitted data queries, or an interactive query training module.

9. The computer-implemented method of claim 1, wherein the computing query optimization action is undertaken based on the general score being below a predetermined threshold score.

10. The computer-implemented method of claim 1, further comprising assigning, by the server system, a category classification for each of the data queries, wherein the category classification for each data query is indicative of a quality of the data query.

11. The computer-implemented method of claim 1, wherein the score for each data query is based on a presence of at least one query parameter in the data query.

12. The computer-implemented method of claim 11, wherein the at least one query parameter comprises at least one of unbalanced joins between different tables, use of star select in the data query, lack of filtering techniques in the data query, or requesting excess data by the data query over what is required to resolve the data query.

13. The computer-implemented method of claim 1, wherein the assigning of the score comprises:
comparing at least one query parameter of the data query to one or more parameter criteria to identify one or more query patterns, wherein each of the one or more query patterns is associated with a specific quality category classification; and
generating the score to assign to the data based on a presence of the one or more query patterns in the data query.

14. The computer-implemented method of claim 13, wherein the assigning of the score is further based on a computing resource usage associated with the data query or the at least one query parameter.

15. A database system for an enterprise, the database system comprising:
a distributed database management platform comprising a plurality of nodes configured to store and process data queries; and
a server in communication with the distributed database management platform, the server being configured to execute a data query analysis application that:
receives data queries from users associated with the enterprise for data stored in the distributed database management platform;
assigns a score to each of the data queries, wherein the score for a data query is indicative of a quality of the data query;
generates, based on the scores for the data queries, a general score for at least one user group, wherein the at least one user group comprises one or more users that are associated with the enterprise; and
automatically undertakes a computing query optimization action for the at least one user group based on the general score for the at least one user group.

16. The database system of claim 15, wherein:
the distributed database management platform comprises a Hadoop distributed database management platform; and
the data queries comprise SQL queries.

17. The database system of claim 16, wherein the computing query optimization action comprises reducing an ability of the at least one user group to submit data queries to the distributed database management platform.

18. The database system of claim 17, wherein reducing the ability of the at least one user group to submit data queries to the distributed database management platform comprises reducing computing resources of enterprise available to accounts associated with the at least one user group.

19. The database system of claim 17, wherein reducing the ability of the at least one user group to submit data queries to the distributed database management platform comprises placing accounts associated with the at least one user group in a longer query submission queue time for the distributed database management platform.

20. The database system of claim 16, wherein the server is configured to assign the score by:
comparing at least one query parameter of the data query to one or more parameter criteria to identify one or more query patterns, wherein each of the one or more query patterns is associated with a specific quality category classification; and
generating the score to assign to the data based on a presence of the one or more query patterns in the data query.
